(19) United States
(12) Patent Application Publication
(10) Pub. No.: US 2019/0247872 A1
(43) Pub. Date: Aug. 15, 2019

(54) APPLICATION COMPONENT OF A ROTARY ATOMIZER MADE OF FOAM MATERIAL AND ITS PRODUCTION METHOD AND APPLICATION SPRAYING METHOD

(71) Applicant: EISENMANN SE, Boblingen (DE)

(72) Inventors: Svenja Vetter, Neustetten (DE); Herbert Schulze, Aidlingen (DE)

(21) Appl. No.: 16/303,713

(22) PCT Filed: Apr. 18, 2017
(86) PCT No.: PCT/EP2017/059177

§ 371 Date: Nov. 21, 2018

(30) Foreign Application Priority Data
May 24, 2016 (DE) 10 2016 006 177.4

(51) Int. Cl. B05B 3/10; B05B 15/18; B05D 1/02

(52) U.S. Cl. CPC B05B 3/1014; B05B 5/0407; B05D 1/02; B05B 15/18

(57) ABSTRACT

An application component for a rotary atomizer, having a base body which has an outflow surface for an application material that is to be atomized. In order to obtain a weight which is as low as possible while providing a highest possible strength, the base body is made in its interior at least in some regions of a material having cellular structures. Possible production methods of the component are, inter alia, an integral foam casting process, in particular an integral metal foam casting process, or a generative process.

### BACKGROUND OF THE INVENTION

### 1. Field of the Invention

The invention relates to an application component for a rotary atomizer with a main body comprising an outflow surface for an application material to be atomized.

The invention further relates to a method for producing such an application component and to a method for coating objects using a rotary atomizer comprising such an application component.

### 2. Description of the Prior Art

Rotary atomizers are often used as application devices when coating objects, for example vehicle bodies and parts thereof.

Such rotary atomizers have a rapidly rotating application component, such as for example a bell cup or a spray disk. The material to be applied is deposited via a central channel on the outflow surface of the application component, on which the material to be applied moves outwards and is atomized and sprayed off as a result of the centrifugal forces acting thereon.

In order to minimize to the greatest possible extent the mechanical requirements placed on the drive, bearing mounting and an industrial robot carrying the application device, the rotating application component needs to have the lowest possible weight and nevertheless sufficient mechanical strength to absorb the centrifugal forces that arise.

A bell cup is therefore known from EP 2 349 582 B1 in which the main body is coated with a coating which serves to provide mechanical reinforcement. The material of this coating has a higher mass density than the material proper of the main body.

According to EP 2 349 582 B1, this is associated with higher mechanical strength.

However, production of such a bell cup is complex, and therefore other approaches to solving the problem of obtaining a maximally light but nevertheless rotationally stable application component are desirable.

### SUMMARY OF THE INVENTION

It is therefore the object of the invention to provide a rotating application component for a rotary atomizer which has the greatest possible mechanical strength alongside the lowest possible weight. Furthermore, a corresponding production method and a method for coating objects are to be provided.

With regard to the application component, this object is achieved by an application component as mentioned above, in which the main body is formed in the interior at least in places from a material with cellular structures.

The inventors have identified that the use of a material with cellular structures is advantageous over an application component made from solid material in terms of achieving a weight reduction.

Cellular structures are here understood to mean structures which have a plurality of small cavities, preferably with diameters of less than 5 mm, in particular less than 2 mm. In this way, a material with cellular structures may have a quotient of bulk density and true density (also known as relative density) of between 10% and 60%, in particular between 30% and 50%. Bulk density is here understood to mean the density of a solid based on the volume including the cavities. The true density relates, in contrast, to the actual solid material and is often also known as mass density.

The cellular structures have mutually supporting thin-walled intermediate webs, such that a main body made from a material with cellular structures is of a markedly higher strength than a main body formed as a hollow body with the same bulk density.

The main body may comprise a material with cellular structures virtually throughout or indeed only in sub-regions.

Examples of materials with cellular structures include cellular materials with foam, fibrous, wire, hollow sphere or honeycomb structures and the like, which comprise open or closed cavities.

Above all, the material with cellular structures may also be formed of a material which has a higher true density than or the same true density as a material used on the main body for an outer reinforcing shell. The main body itself may in this respect comprise two different materials.

Due to the resultant reduction in the total mass of the application component, the mechanical loads on the bearing mounting, drive and the industrial robot are reduced. The forces arising during braking and acceleration of the rotating application component are also lower.

Advantageous further developments are stated in the subclaims.

The material with cellular structures is preferably a metal foam, in particular an aluminum metal foam, a plastics foam and/or a ceramic foam. Such foams allow relatively simple manufacture of the cellular structures. Purposefully constructed structures such as for example honeycomb structures or the like are also feasible according to the invention as cellular structures. However, the use of foams is particularly advantageous, since they may have high strengths alongside low bulk densities.

The material with cellular structures preferably comprises two different materials. Thus, the cavities of the cellular structures may be filled with another, in particular lighter, material than the material which forms the intermediate webs.

This allows the mechanical properties of the main body to be optimized still further.

The cellular structures preferably have a defined internal geometry. This is the case for example with a hexagonal honeycomb structure or the like. In contrast, the internal geometry is not defined in the case of a foam, since it is impossible to prescribe in the production process what size and shape an individual pore will ultimately have. A defined internal geometry is above all advantageous for a defined weight distribution within the main body. Since weight distribution influences the moment of inertia and thus the smooth operation of the application component, a predictable weight distribution is of importance.

In terms of a method for producing an application component for a rotary atomizer, the invention provides a method having the following steps:
a) producing the application component with a main body which comprises an outflow surface for an application material to be atomized and the interior of which is formed at least in places from a material with cellular structures.

Production of the main body preferably comprises the following steps:
a) providing a mold, which defines the outer contour of the main body;
b) injection molding a solid material provided with a blowing agent.

Such a method may be used to produce main bodies which at least in places have foam materials as the material with cellular structures.

Production of the main body preferably involves structural foam molding, in particular structural metal foam molding. The process may be high pressure structural foam molding or low pressure structural foam molding. In this way, a main body may be produced which comprises a compact outer region and nevertheless consists internally of a light foam material. It is furthermore possible to form a solid material shell around an internal foam volume of the same material. This does away with complex joining methods for individual parts of the same or different material.

Production of the main body preferably comprises an additive manufacturing process for producing the cellular structures. 3D printing methods, preferably 3D metal printing methods, are particularly suitable for this purpose. The main body may in this case be produced together with the cellular structures in the inner region in one step from one material, for example a metal alloy.

Furthermore, it is still possible with all these methods subsequently in the usual way to make functional modifications to the outflow surface of the main body. The outflow surface may for example be machined (grinding, lapping etc.) or provided with special friction- and/or wear-reducing coatings.

With regard to the method of coating objects, the object according to the invention is achieved with the following steps:
a) providing an application device with an application component according to the invention;
b) coating of the objects using the application device.

Objects to be coated are here above all vehicle bodies or parts thereof. An electrostatic coating method may in particular be used for this purpose. In this case, the application component should be made from an electrically conductive material or have a corresponding coating.

### BRIEF DESCRIPTION OF THE DRAWINGS

Exemplary embodiments of the invention are explained in greater detail below with reference to the drawings, in which:

FIG. 1 shows a section through a rotary atomizer with a bell cup of solid foam;

FIG. 2 shows a section through a rotary atomizer with a bell cup, comprising a foam-filled hollow article as bell cup;

FIG. 3 shows a section through a rotary atomizer with a bell cup of structural foam.

### DESCRIPTION OF PREFERRED EXEMPLARY EMBODIMENTS

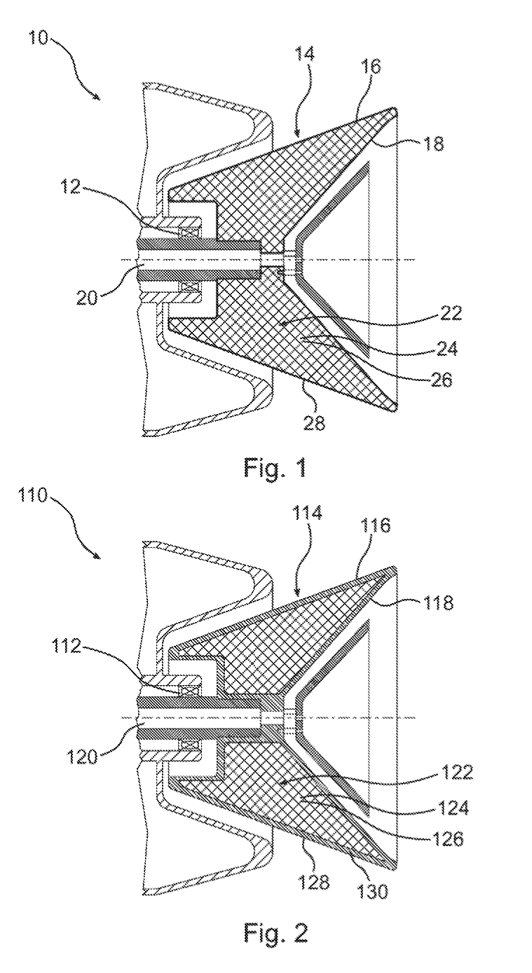

FIG. 1 shows a rotary atomizer 10 comprising a bell cup 14 as application component, said bell cup being mounted by way of a bearing 12 and rotating rapidly when in operation.

The bell cup 14 comprises a main body 16, the mass of which makes up a major part of the total rotating mass. A substantially internally tapered outflow surface 18 is provided on the main body 16 of the bell cup 14, to which surface coating material to be applied is fed by a feed pipe 20. Through rotation of the bell cup 14, the coating material is brought to the edge of the bell cup 14 and atomized there. Further details of the mode of operation of such a rotary atomizer 10 are generally known and of no further significance for the present invention.

The main body 16 is made at least in its inner region, as indicated by the checked hatching, of a foam material 22, in particular a high strength aluminum foamed metal alloy. Such a foam material 22 constitutes a material with cellular structures, meaning that the main body 16 comprises a plurality of hollow cavities, the foam pores 24, in its interior, the intermediate webs 26 of which provide mutual support.

The main body 16 further comprises a skin 28, which smoothly encloses the inner region of the main body 16. In the region of the outflow surface 18, the skin 28 of the main body 16 is further provided with a friction- and wear-reducing coating, which is not visible in the figure.

FIG. 2 shows a rotary atomizer 110, which likewise comprises a bell cup 114 mounted by way of a bearing 112. The bell cup 114 in this case has a main body 116, in which an outer region 130 is molded from a solid material, for example a high strength aluminum alloy. An inner region further comprises a foam material 122, in particular a foamed aluminum alloy, which has a true density which is identical to or greater than that of the aluminum alloy of the solid material outer region 130. Due to the cavities in the foam material 122, however, a lower bulk density is obtained in the inner region than in the outer region. Such a bell cup 114 may for example be manufactured by sandwich construction.

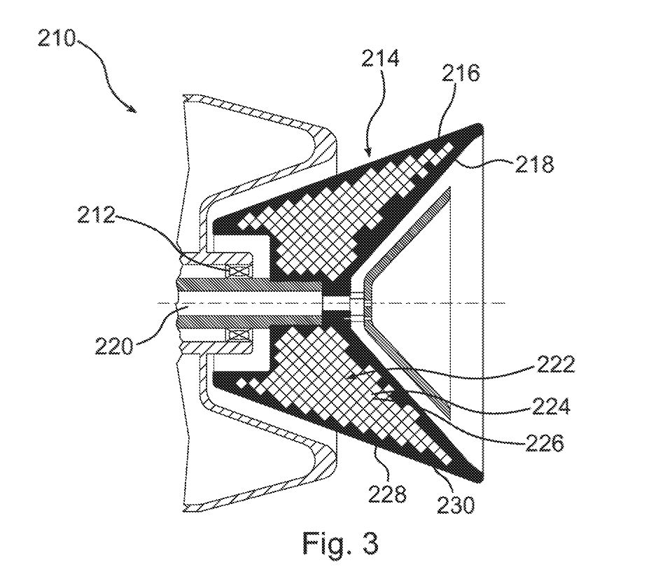

FIG. 3 shows a rotary atomizer 210, in which the main body 216 of the bell cup 214 takes the form of a structural foam component. In this case, an outer region of a solid material merges continuously into an inner region of foam material 222.

Such a structural foam component may be produced by high or low pressure structural foam molding. In the low pressure method, a mold is underfilled with a melt mixed with blowing agents. The foaming melt then fills the mold. Vigorous cooling at the mold wall results in a compact outer region of solid material. The thickness of the outer region may be influenced, depending on process control and blowing agent concentration.

In the high pressure method, the mold is firstly completely filled under pressure. After a time delay, the mold volume is then enlarged for example by a core puller. This lowers the pressure abruptly and gases dissolved in the melt can expand in the as yet unsolidified inner region and foam the melt.

In this way, the main body 216 of the bell cup 214 may be produced in a single molding step.

Instead of a foam material, cellular structures with defined geometries may also be used in the above-described exemplary embodiments. Thus, for example a cellular structure in the form of a honeycomb may also be provided in the inner region of the main body 14. Such honeycomb structures may be produced using an additive manufacturing process such as for example a 3D metal printing method, such that the main body may likewise be produced substantially in one step.

What is claimed is:

1. An application component for a rotary atomizer comprising:
a main body comprising an outflow surface for an application material to be atomized, wherein
an interior of the main body is formed, at least in places, from a material with cellular structures.

2. The application component as claimed in claim 1, wherein the material with cellular structures is one or more of a metal foam, an aluminum metal foam, a plastics foam and/or a ceramic foam.

3. The application component as claimed in claim 1, wherein the material with cellular structures comprises two different materials.

4. The application component as claimed in claim 1, wherein the cellular structures have a defined geometry.

5. A method for producing an application component for a rotary atomizer comprising the following step:
a) producing an application component with a main body which comprises
an outflow surface for an application material to be atomized and
an interior of which is formed at least in places from a material with cellular structures.

6. The method as claimed in claim 5, wherein production of the main body comprises the following steps:
a) providing a mold which defines an outer contour of the main body;
b) injection molding a solid material provided with a blowing agent.

7. The method as claimed in claim 5, wherein production of the main body comprises structural foam molding.

8. The method as claimed in claim 5, wherein production of the main body comprises an additive manufacturing process for producing the cellular structures.

9. A method for coating objects comprising the following steps:
a) providing an application device with an application component as claimed in claim 1; and
b) coating the objects using the application device.

10. The method as claimed in claim 5, wherein production of the main body comprises structural metal foam molding.
